(19) United States
(12) Patent Application Publication
(10) Pub. No.: US 2005/0036572 A1
(43) Pub. Date: Feb. 17, 2005

(54) Method of rate conversion together with I-Q mismatch correction and sampler phase adjustment in direct sampling based down-conversion

(76) Inventors: Khurram Muhammad, Richardson, TX (US); Robert B. Staszewski, Garland, TX (US); Imtinan Elahi, Richardson, TX (US)

Correspondence Address: TEXAS INSTRUMENTS INCORPORATED, P O BOX 655474, M/S 3999, DALLAS, TX, 75265, US

(21) Appl. No.: 10/641,235

(22) Filed: Aug. 14, 2003

(51) Int. Cl. H04L 27/06

(52) U.S. Cl. 375/322

(57) ABSTRACT

A method of digital resampling converts a channel dependent rate to a fixed rate while correcting gain and phase mismatch between I and Q branches in the resampling process and adjusts the sampler phase for T-spaced equalization.

### RELATED PATENT APPLICATIONS

This application is related to co-pending U.S. Patent Application Publication entitled Sigma-Delta (Sigmadelta) Analog-To-Digital Converter (ADC) Structure Incorporating A Direct Sampling Mixer, Pub. No. US 2003/0080888 A1, filed on Oct. 17, 2002, and published May 1, 2003, by Khurram Muhammad, Robert B. Staszewski, Feng Chen and Dirk Leipold; and co-pending U.S. Patent Application Publication entitled Direct Radio Frequency (RF) Sampling With Recursive Filtering Method, Pub. No. US 2003/0035499 A1, filed on Jul. 8, 2002, and published Feb. 20, 2003, by Robert B. Staszewski, Khurram Muhammad, Kenneth J. Maggio and Dirk Leipold, both applications incorporated by reference in their entirety herein.

### BACKGROUND OF THE INVENTION

1. Field of the Invention

This invention relates generally to discrete time radio frequency (rf), and more particularly to a structure and method of digital resampling to convert a channel dependent rate to a fixed rate while correcting gain and phase mismatch between I and Q branches in the resampling process and adjusting the sampler phase for T-spaced equalization.

2. Description of the Prior Art

A discrete time RF receiver front-end architecture can be implemented using a direct sampling mixer that down-converts the received signal to a very low intermediate frequency (IF). The sampling mixer provides data samples at a rate depending up on the channel that is downconverted.

It would be both desirable and advantageous to provide a method of digital resampling not only to convert the channel dependent rate to a fixed rate, but also to correct gain and phase mismatch between I and Q branches in the resampling process and adjust the sampler phase for T-spaced equalization.

### SUMMARY OF THE INVENTION

The present invention is directed to a structure and method of digital resampling to convert a channel dependent rate to a fixed rate while correcting gain and phase mismatch between I and Q branches in the resampling process and adjusting the sampler phase for T-spaced equalization.

According to one embodiment, a radio receiver architecture comprises a digital resampler comprising: an I-resampler unit; and a Q-resampler unit, wherein the digital resampler is operational to generate interpolated I and Q output data in response to an I-resampler delay signal, a Q-resampler delay signal, and further in response to I and Q input data streams synchronized on a local oscillator derived clock, such that the interpolated I and Q output data rate is substantially fixed and substantially independent of channel frequency variations.

According to another embodiment, a method of converting a channel dependent sampling rate to a fixed rate comprising the steps of: providing a radio receiver comprising a digital resampler having an I-resampler unit responsive to a first delay signal and a Q-resampler unit responsive to a second delay signal, and further having a calculation engine; and resampling channel dependent I-phase input data and the channel dependent Q-phase input data in synchronization with a local oscillator derived clock and in response to in phase (I) and quadrature (Q) resampling signals and generating interpolated I and Q output data therefrom.

According to yet another embodiment, a radio receiver architecture comprises a digital resampler operational to generate interpolated I and Q output data in response to an I-resampler delay signal, a Q-resampler delay signal, and further in response to I and Q input data streams synchronized on a local oscillator derived clock, such that the interpolated I and Q output data rate is substantially fixed and substantially independent of channel frequency variations.

According to still another embodiment, a radio receiver architecture operates at least partially in a sampled domain such that the sampling rate throughout the receive path is directly derived from a local oscillator clock, and such that the local oscillator output clock edges are divided by an integer number, wherein the divided output clock edges and derivatives thereof are operational to generate decimated signal sampling clocks.

According to still another embodiment, a radio receiver architecture comprises a digital resampler operational to generate interpolated I and Q output data in response to at least one resampler delay signal, and further in response to I and Q input data streams synchronized on a local oscillator derived clock, such that the interpolated I and Q output data rate is substantially fixed and substantially independent of channel frequency variations.

According to still another embodiment, a method of converting a channel dependent sampling rate to a fixed rate comprises the steps of: providing a radio receiver comprising a digital resampler responsive to at least one delay signal, and further having a calculation engine; and resampling channel dependent input data in synchronization with a local oscillator derived clock and in response to resampling signals and generating interpolated output data therefrom.

According to still another embodiment, a radio receiver architecture comprises a digital resampler operational to generate interpolated output data in response to at least one resampler delay signal, and further in response to input data streams synchronized on a local oscillator derived clock, such that the interpolated output data rate is substantially fixed and substantially independent of channel frequency variations.

### BRIEF DESCRIPTION OF THE DRAWINGS

Other aspects and features of the present invention and many of the attendant advantages of the present invention will be readily appreciated as the invention becomes better understood by reference to the following detailed description when considered in connection with the accompanying drawing figures wherein:

FIG. 1 illustrates a direct sampling mixer providing a temporal mixer operation at a desired RF rate;

FIG. 2 illustrates a technique of discrete signal processing in a multi-tap direct sampling mixer (MTDSM);

FIG. 3 is a schematic diagram illustrating a MTDSM according to one embodiment;

FIG. 4 is a diagram illustrating the principle of polynomial interpolation using first order interpolation;

FIG. 5 is a diagram illustrating a Farrow structure;

FIGS. 6a,b-8a,b are plots illustrating performance of Lagrange interpolation associated with a channel of interest for first and second order polynomials in the frequency and time domains respectively and with 1%, 10% and 20% sampling rate increases respectively;

FIGS. 9a,b-11a,b are plots illustrating performance of Lagrange interpolation associated with an adjacent channel approximately 4 MHz away for first and second order polynomials in the frequency and time domains respectively and with 1%, 10% and 20% sampling rate increases respectively;

FIG. 12 is a block diagram illustrating a non-interpolative up-sampler for converting a channel dependent data rate to fixed rate data;

FIGS. 13-18 are plots illustrating an up-sampled data stream spectrum associated with the up-sampler shown in FIG. 13 when the new data rate is respectively 0.5%, 1.0%, 2.0%, 5.0%, 10.0% and 20.0% higher than the original rate for various data insertion schemes;

FIGS. 19-24 are plots illustrating an up-sampled data stream spectrum associated with the up-sampler shown in FIG. 13 when the new data rate is respectively 0.5%, 1.0%, 2.0%, 5.0%, 10.0% and 20.0% lower than the original rate for various data insertion schemes;

FIG. 25 is a non-interpretive up-sampler for converting a channel dependent data rate to fixed rate data according to another embodiment;

FIG. 26 is a simplified block diagram illustrating a system architecture for implementing rate conversion together with IQ mismatch correction and sampler phase adjustment in direct sampling based down-conversion according to one embodiment of the present invention;

FIG. 27 is a block diagram illustrating an algorithm for implementing IQ phase mismatch cancellation in a quadrature receiver using a polynomial resampler according to one embodiment of the present invention;

FIG. 28 is shows plots illustrating convergence properties of δ shown in FIG. 27 for three different frequencies;

FIG. 29 is a block diagram illustrating an algorithm for implementing a wider band IQ phase mismatch correction in a quadrature receiver using a polynomial resampler according to one embodiment of the present invention;

FIG. 30 is a block diagram illustrating an algorithm for implementing correction of gain mismatch; and

FIG. 31 is a top-level system block diagram illustrating a resampling technique within a complete RX chain according to one embodiment of the present invention.

While the above-identified drawing figures set forth alternative embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION OF THE PREFERRED EMBODIMENTS

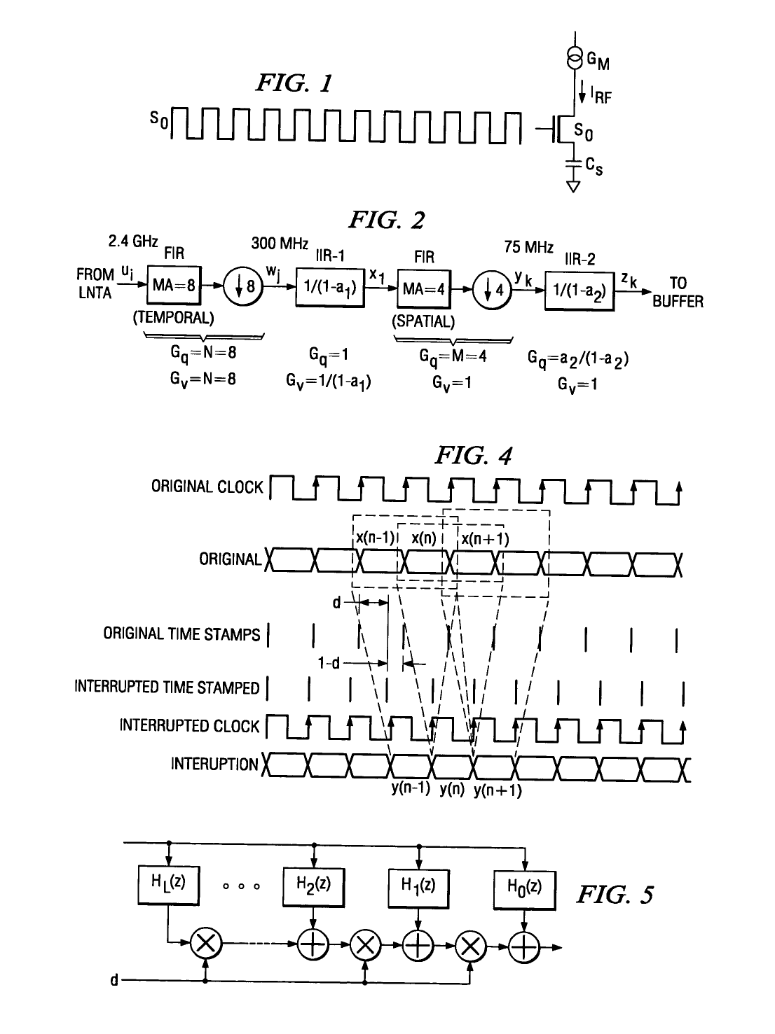

FIG. 1 illustrates a current-mode direct sampling mixer that provides a down-converted data stream with a rate equal to the frequency of the local oscillator. The basic idea of the current-mode direct sampling mixer is described to provide a better understanding of the inventive embodiments described herein below. A low-noise transconductance amplifier (LNTA) converts the received RF voltage v_{RF} into i_{RF} in the current domain through the transconductance gain gₘ. The current i_{RF} gets switched by the half-cycle of the local oscillator and integrated into the sampling capacitor, Cₛ Since it is difficult to switch the current at the RF rate, it is merely redirected to an identical sampler (not shown) that is operating on the opposite half-cycle of the local oscillator clock. As the down-conversion frequency is fixed but the channel frequency varies in a wide range, the rate of the down-converted data stream is variable despite being fixed for a particular channel of interest. A more detailed description is provided in co-pending U.S. Patent Application Publication entitled Direct Radio Frequency (RF) Sampling With Recursive Filtering Method, Pub. No. US 2003/0035499 A1, filed on Jul. 8, 2002, and published Feb. 20, 2003, by Robert B. Staszewski, Khurram Muhammad, Kenneth J. Maggio and Dirk Leipold, incorporated by reference in its entirety herein.

The present inventors recognized the value of using digital resampling in order to convert the variable data rate stream to a fixed rate data stream that is independent of the channel of interest. The basic idea in digital resampling is to apply polynomial interpolation to the available down-converted data stream and obtain the desired data stream at a fixed rate. The quality of interpolation depends on the oversampling ratio of the signal of interest and the order of the polynomial.

FIG. 2 shows the block diagram from the signal processing standpoint for one specific implementation of a multi-tap direct sampling mixer constructed on this current-mode sampling principle. In this figure, the local oscillator (LO) oscillates at f_{LO}=2.4 GHz. The temporal taps N=8 and spatial taps M=4.

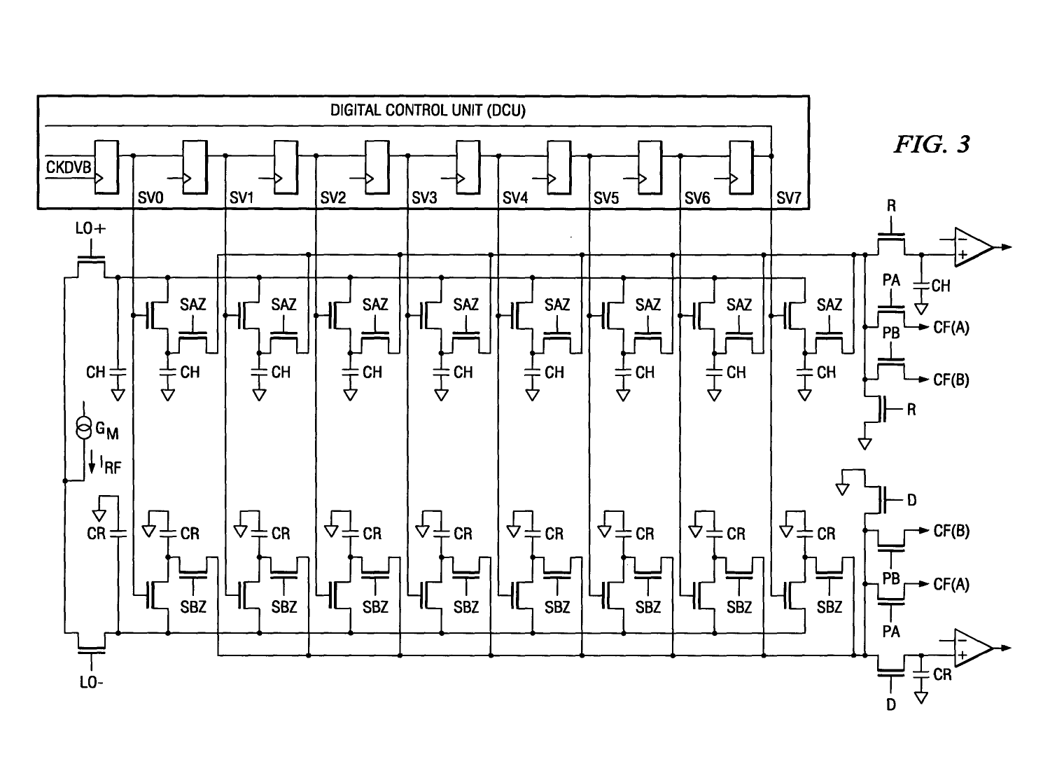

The scheme presented in FIG. 2 can have many implementations: one such scheme shown in FIG. 3 is described in more detail in co-pending U.S. Patent Application Publication entitled Direct Radio Frequency (RF) Sampling With Recursive Filtering Method, Pub. No. US 2003/0035499 A1, filed on Jul. 8, 2002, and published Feb. 20, 2003, by Robert B. Staszewski, Khurram Muhammad, Kenneth J. Maggio and Dirk Leipold, incorporated by reference in its entirety herein.

The recursive IIR filter is implemented using C_{H}, a history capacitor, charge sharing one of the rotating capacitors CR. The first temporal taps are implemented by accumulation of successive RF current-mode samples on CH and one of the CR. This operation performs the IIR filtering (labeled IIR-1 in FIG. 2) and the accompanied decimation. M rotating capacitors are charge shared with the capacitor CB to implement an M-tap first order sinc filter with decimation. Capacitor CB acts like a history capacitor forming the second IIR filter (IIR-2 in FIG. 2). The final filtered and down-converted channel of interest is read-off at the output of the IF amplifier (IFA). This is only one possible implementation to show the concept where variable rate data can arise.

For f_{LO}=2.4 GHz, the data rate at various points in the chain is shown in FIG. 2. The data rate at the output of the IFA is at 75 Msps. When the LO is changed to a different frequency such as 2401 Msps, the data rate at the output of the IFA is 75.03125 Msps. Similarly for the final channel of Bluetooth spectrum at 2.48 GHz, the output data rate of the IFA equals 77.5 Msps.

Subsequent stages following the IFA may desire a constant data rate independent of the channel of interest since the demodulator in the baseband is generally architected on the assumption of a constant rate input. Data rate conversion in the analog domain is cumbersome and power inefficient. One may convert the digital to analog and back to digital at the desired sampling rate; however, such a solution is not efficient. The receiver may require one or more stages of filtering before the analog-to-digital conversion. These stages including the ADC operate at a derivative of the LO frequency, hence, moving the data rate conversion problem to the digital domain.

Interpolative Resampling

It is well known that a wealth of literature exists on digital resampling. At least one reference provides a general survey of many interpolative techniques used in fractional resampling. The goal of resampling is to provide a desired delay to the input signal without changing the frequency components. This is accomplished by employing a polynomial interpolation of the samples around the desired sample as shown in FIG. 4. If a linear interpolation is desired, the simplest sample at delay d with respect to a given sample x(n−1) and 1−d with respect to x(n) is given by y(n−1)=(1−d)·x(n−1) +d·x(n). In general, a higher order polynomial interpolation may be used to obtain the interpolated data. Equivalently, this problem can be formulated as one providing a variable phase delay to the original data stream. The main issue in such interpolation is to construct an efficient interpolative filter which does not require full multipliers as required by higher orders of d, since d changes from sample to sample.

The most commonly used implementation in digital resampling is the Farrow structure which implements interpolation to arbitrary phase delay using a bank of fixed coefficient FIR filters independent of the desired phase delay. The structure is shown in FIG. 5 and it implements a fractional delay (FD) filter with low-complexity. The desired delay d is provided as an input and the fixed coefficient filter provides the interpolated data samples at the output. In contrast to IIR based solutions which provide transients as d changes, this solution provides a much simpler implementation which can use many of existing complexity reduction approaches applied to fixed coefficient digital filters. The shift register in Farrow structure can be shared between the filter banks. Existing techniques for common subexpression elimination can be used to reduce the complexity of the adder trees in each bank. The number of banks is determined by the order of the polynomial.

Lagrange Interpolative Resampling

Lagrange interpolation is a widely used polynomial interpolation technique which implements a digital filter with coefficients

$$h ( n ) = {\prod }_{k = 0 , k \neq n}^{L} \frac{d - k}{n - k} \qquad ( 1 )$$

for n=0, 1, . . . , N. The coefficients for N=1, 2 and 3 are narrated in Table I below.

TABLE I
COEFFICIENTS OF LAGRANGE INTERPOLATOR FOR VARIOUS ORDERS

| Order | h(0) | h(1) | h(2) | h(3) |
|---|---|---|---|---|
| N = 1 | 1-D | D | | |
| N = 2 | (D-1)(D-2)/2 | -D(D-2) | D(D-1)/2 | |
| N = 3 | -(D-1)(D-2)(D-3)/6 | -D(D-2)(D-3)/2 | -D(D-1)(D-3)/2 | D(D-1)(D-2)/6 |

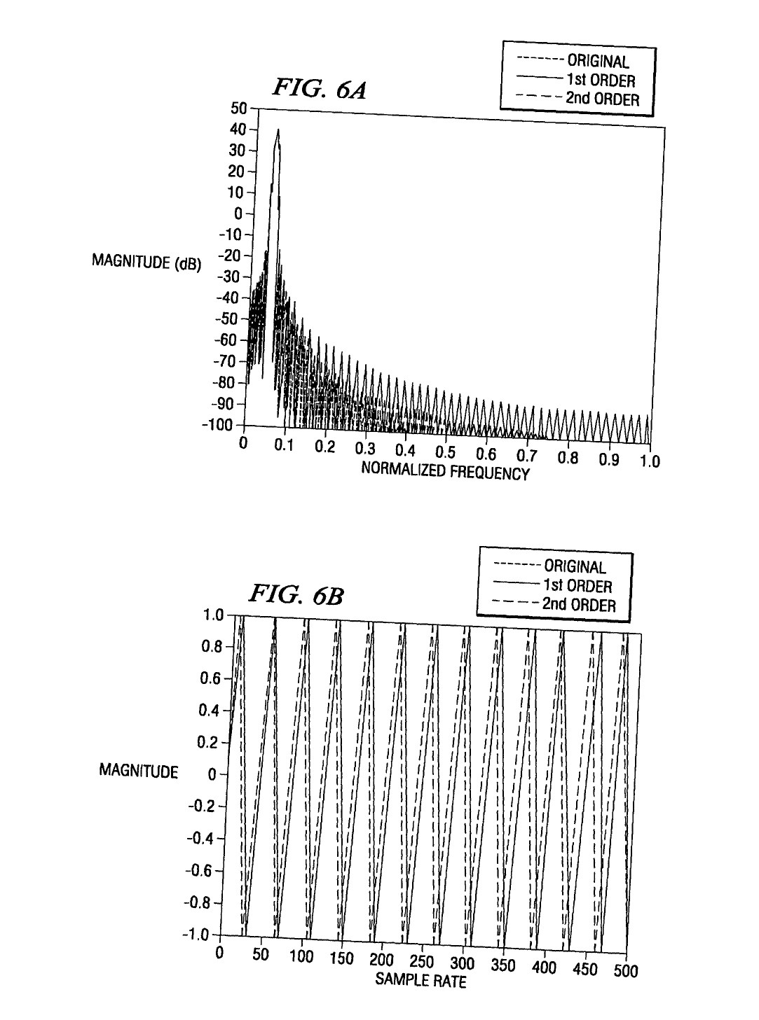

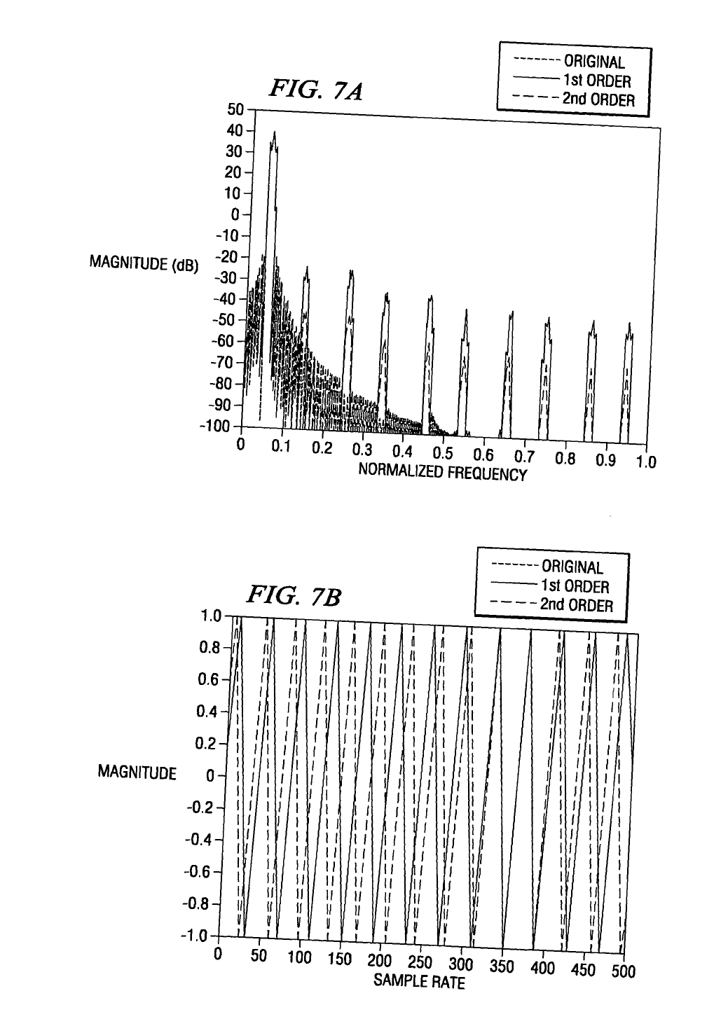

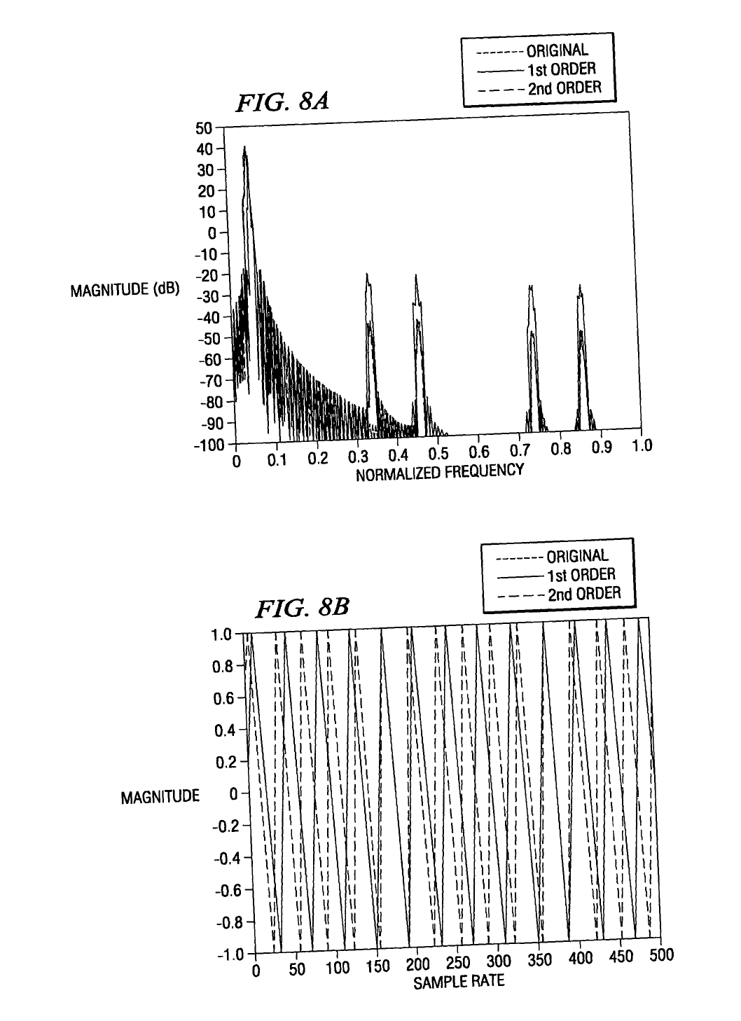

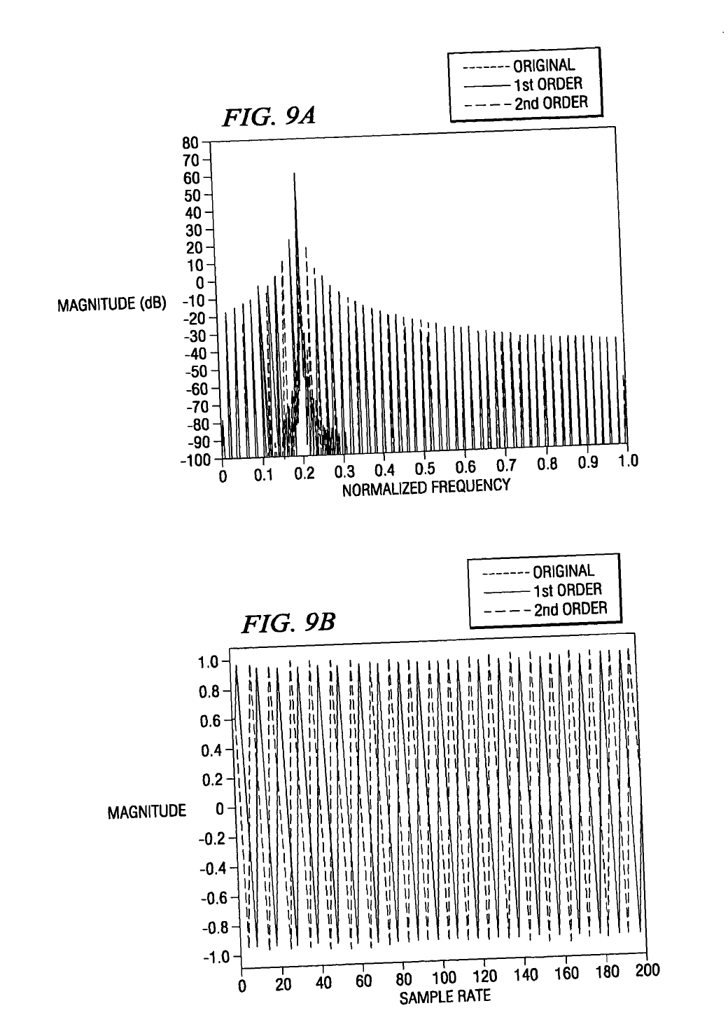

The performance of Lagrange interpolation is shown in FIGS. 6a,b-11a,b for first and second order polynomials. It is clear that the interpolation quality depends upon the frequency of the signal. The interpolation is exceptionally good even for the first and second order polynomials as shown in FIGS. 6a,b-8a,b. For a higher frequency at approximately 4 MHz, FIGS. 9a,b-11a,b show that there are not enough points to do a good interpolation. Hence, for lower frequencies, such as the channel of interest at low-IF, there are enough points to do a very good interpolation with very minimal hardware. This is consistent with the literature which predicts a Lagrange based approach to degrade in quality as frequency of interest increases. Notice however that there is little or no interest in faithful reproduction of frequencies above the channel of interest, unless they cause in-band distortion due to the interpolation.

The foregoing suggests three options for interpolative resampling.
1. Use a lower order polynomial at ADC output. At this point all frequencies are present; however, the ADC output consists of only 2.5 bits and this simplifies the shift registers in the Farrow structure;
2. Use a higher order polynomial at the output of DFIR such that higher frequencies are not present and the FD filter runs at very low rate, therefore low power; and
3. An option between 1 and 2 where the FD filter is inserted with in the decimating FIRs.

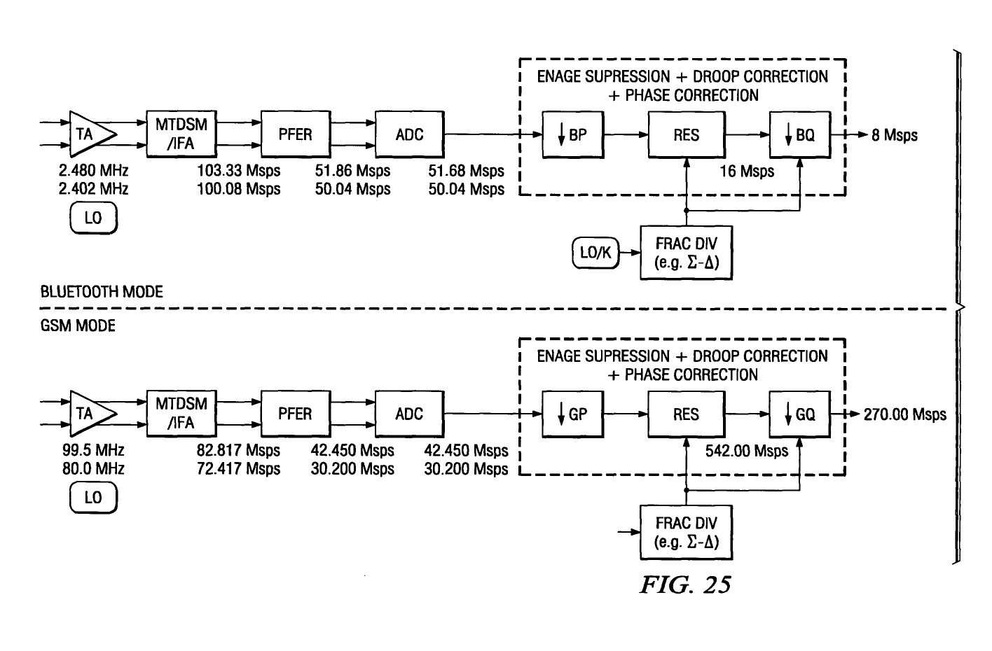

A general version of a receiver with an interpolative resampler is shown in FIG. 25. The resampler block labeled “RES” can be the Farrow structure based FD filter or an alternative such as one described herein below which is a specialized version of the receiver shown in FIG. 25.

Non-Interpolative Resampling

Non-interpolative resampling inserts samples within the given data stream to increase the rate to a desired data rate. The inserted samples can simply be zeros, or a repeat of last value. This scheme avoids use of hardware (FD filter) to do interpolation; however, the power and area savings as a result of this scheme appears as a degradation in the SNDR of the data stream for all signal frequencies in contrast to FD Lagrange polynomial based interpolators described herein before which only distorts high frequencies. As will be shown, the degradation is dependent on the amount of desired rate change and may be acceptable in a particular receiver. Simulations by the present inventors have revealed that an SNDR of greater than 25 dB can be obtained for any rate variation up to 20%. It can be appreciated this is acceptable at the demodulator for Bluetooth as well as GSM standards.

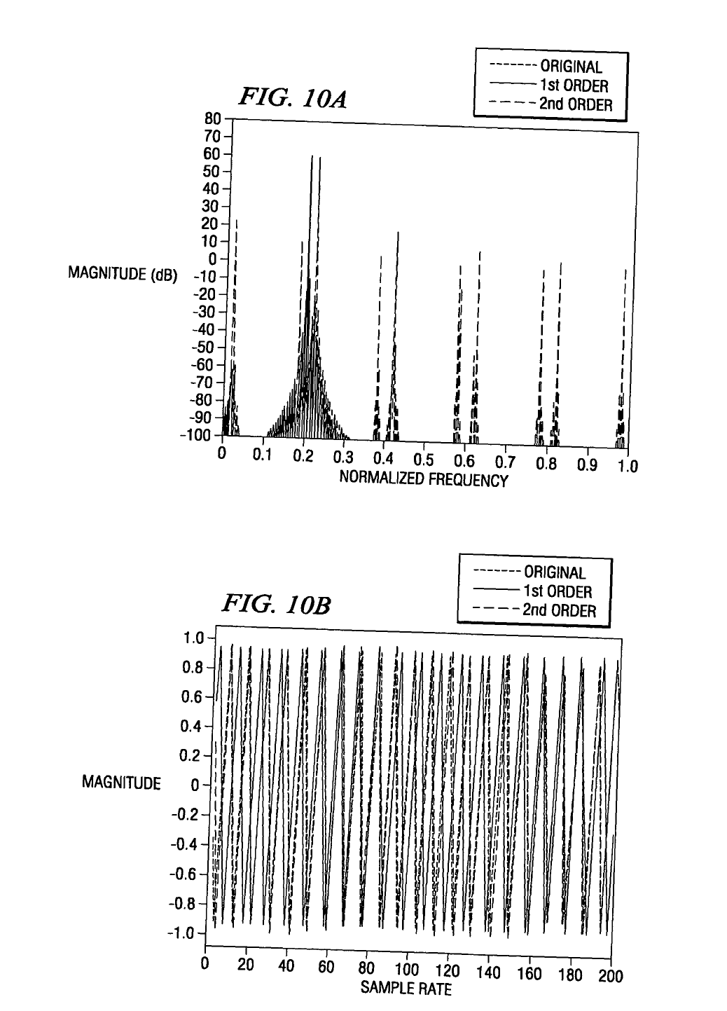

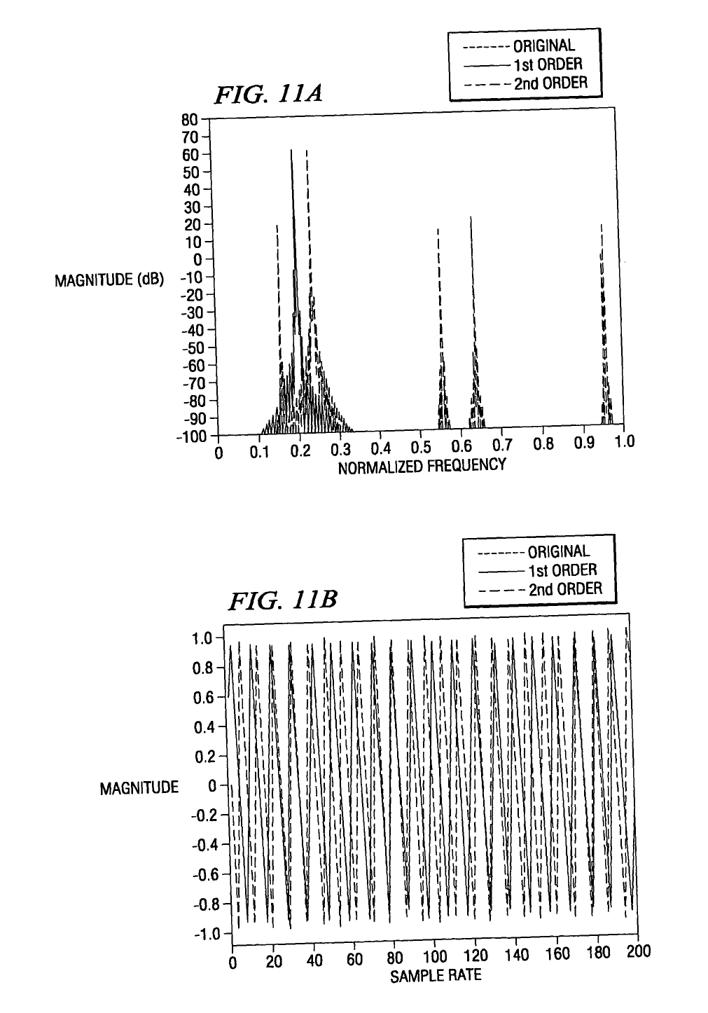

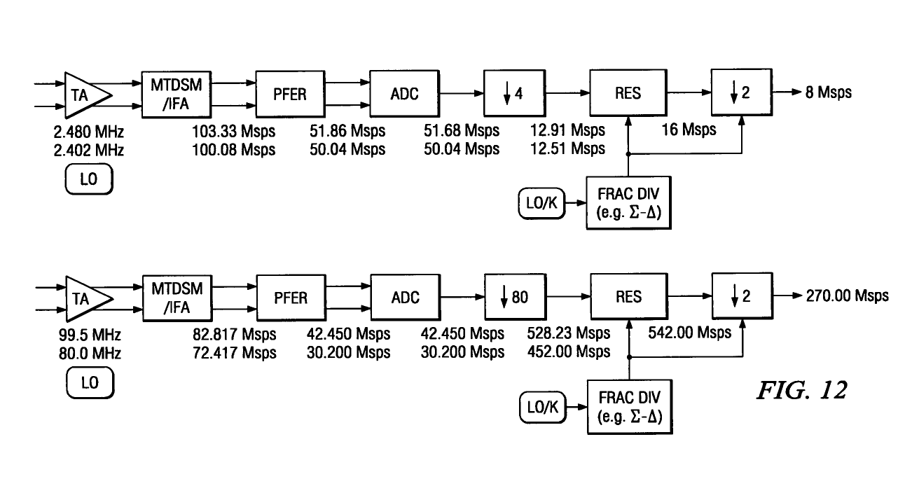

FIG. 12 shows one implementation of a receiver with non-interpolative digital resampling. Two examples are provided in the presented scheme: upper one for Bluetooth band and the other for GSM band. The data rate is channel dependent up to the output of the ADC as the clock signals to these stages are derived from LO. The requirement is to have a fixed data rate at the input to the baseband demodulator. The example assumes a sigma-delta noise shaped ADC, although a flash or any other variant ADC can also be assumed. With the sigma-delta ADC, the digital filters following the quantizer of the ADC are required to remove the high frequency noise in addition to performing the channel selection at very low-IF. For a different kind of ADC, the digital filter must perform channel selection, hence, the characteristics of the digital filter do not depend on the type of the ADC.

FIG. 12 shows one realization of decimation following the ADC. Table II below shows the decimation rates for the two modes in which the receiver operates. The data rates corresponding to the two ends of the spectrum are also shown in FIG. 12.

TABLE II
DECIMATION RATES OF VARIOUS BLOCKS IN BLUETOOTH
AND GSM MODES

| Block | Bluetooth Mode | GSM Mode |
|---|---|---|
| MTDSM/IFA | 24 | 12 |
| PFIR | 2 | 2 |
| ADC | 1 | 1 |
| DFIR-1 | 4 | 80 |
| DFIR-2 | 2 | 2 |

The resampler block converts the variable data rate at the output of DFIR-1 to a fixed rate at the input of DFIR-2. The idea is to avoid using a separate stable frequency source and save power by fractionally dividing the LO or one of its divisions (i.e. LO/k for some positive integer k to obtain the desired fixed rate clock. The resampler uses this clock source to insert new data samples in the data stream at the output of DFIR-1 to obtain a higher data rate. In the examples shown, the inserted new data fills the data varying between 12.51 and 12.91 Msps in the Bluetooth mode to obtain an interpolated data stream at 16 Msps. Similarly, in the GSM mode, the data varying between 452.6 and 518.23 Ksps are interpolated to obtain a data stream at 541.66 Ksps. In this arrangement, droop compensation (DC) and phase compensation (PC) functions can be added on to the DFIR-2 or may be provided in DFIR-1.
Methods for Inserting New Data

In general, inserting new data in a given data stream to obtain a higher data rate compresses the frequency response of the data stream. If the desired data rate is an integer multiple of the given data rate, this is referred to as interpolation and is done in two steps. The first can be done in many ways. The simplest and most straightforward approaches are to 1) insert zeros and 2) repeat the last value. The second step is to remove the images using a digital filter which performs the function of data interpolation. Both approaches of inserting new data between successive samples require trivial hardware which re-synchronizes data from one clock domain to another. In the presence of a subsequent digital filter which is required to decimate the data stream by a factor of 2 as shown in FIG. 12, there is small difference between the two approaches. This is because decimation is preceded with a filter designed to remove the image. For integer ratio conversion, the technique requires very minimal hardware. However, for fractional data rate change, the situation is not very simple. Increasing the data rate by 10% requires inserting a new data sample in every 10 samples of the original data stream. The resulting data stream is at the desired higher rate. It compresses the frequency axis by 10% and it also shows a lot of distortion components. This is the cost of employing a very simple rate change system. The present inventors performed a plurality of experiments to see the effects of the non-interpolative rate conversion approach. The following approaches were considered to insert new data.
Periodic insertion: In this method, a new sample is inserted after every block of N samples to increase the rate by the ratio N+1/N.
Random insertion: In this method, a new sample is inserted in each block of N samples randomly to increase the rate by the ratio N+1/N.
Cyclic insertion: In this method, the new data is inserted in each block of N samples in a cyclic fashion. First block has new insertion at location 1, second block sees the insertion at location 2, and so on.

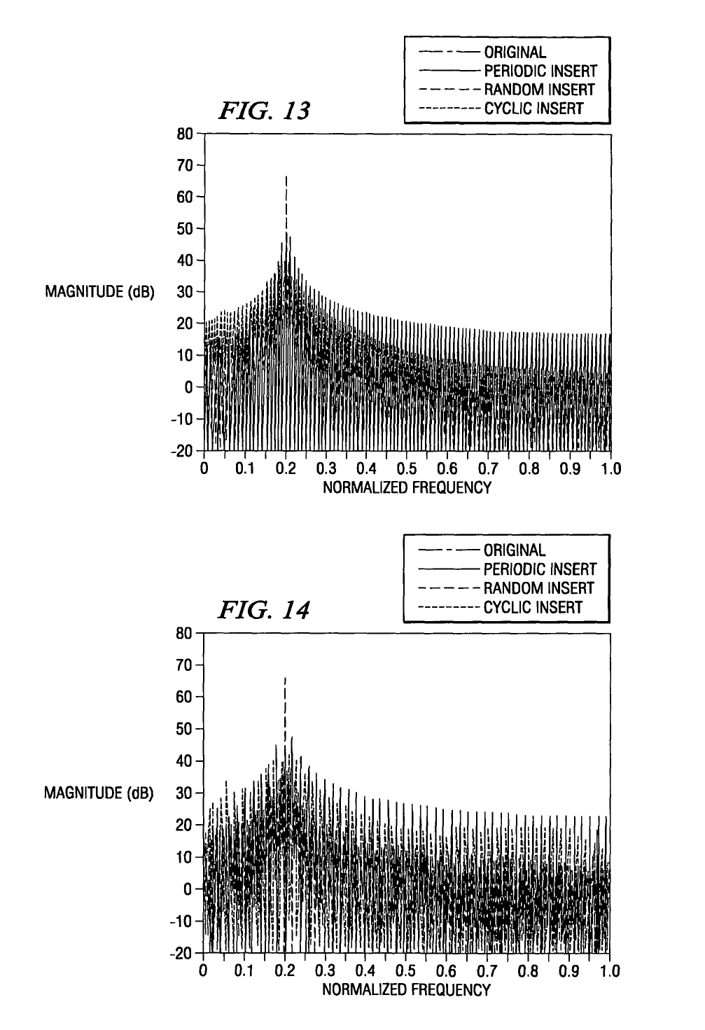

FIG. 13 shows the spectrum of the up-sampled data stream as a result of inserting new data when the new rate was 5% higher than the original rate. Periodic and cyclic data insertion creates tones at different frequencies, while random insertion averages out the distortion and improves SNDR by 6 dB. The SNDR for random insertion is 25 dB. Notice that the SNR is bounded by the SNDR floor in this scheme and no other mechanism exists for reduction of SNR other than the irreducible error floor. In order to avoid this floor, the only option is to go towards an interpolative resampler.

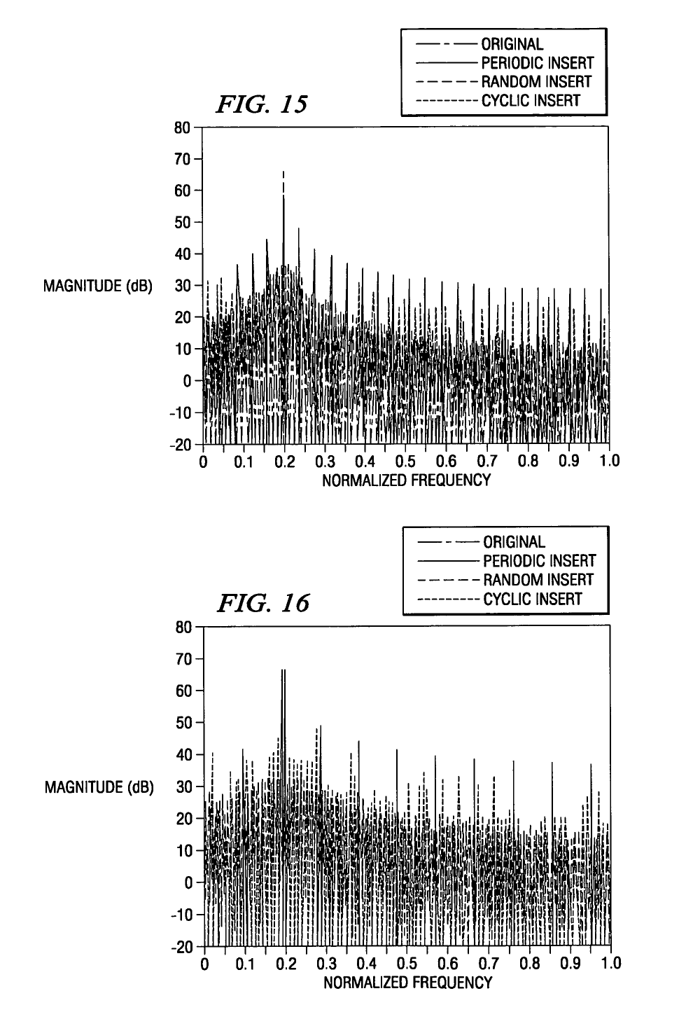

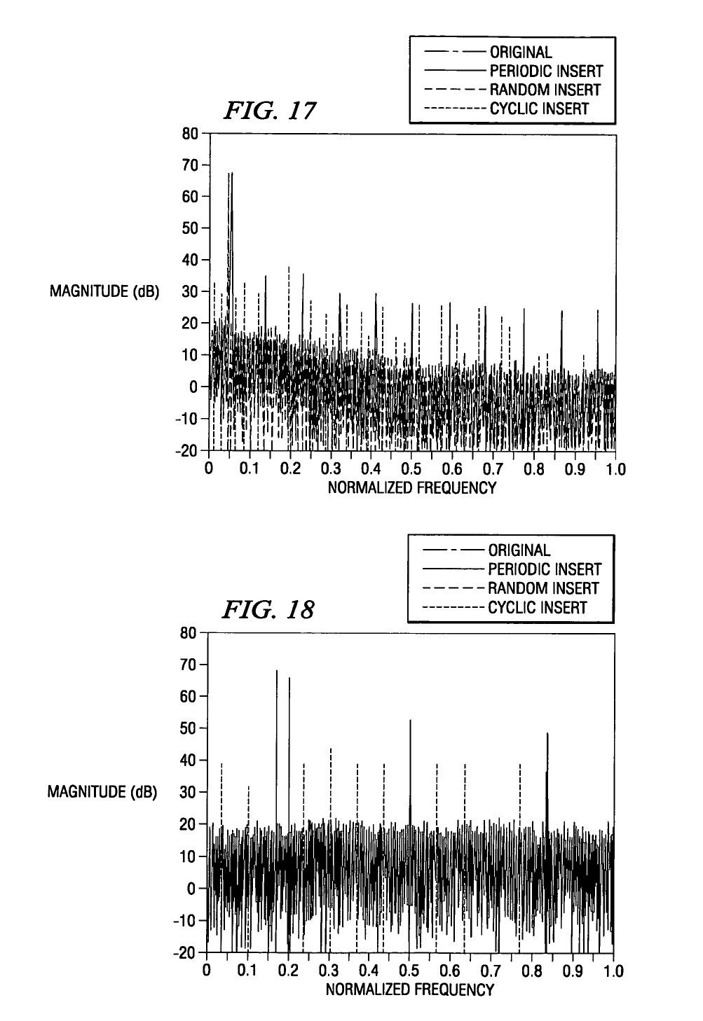

FIGS. 14-18 show the Frequency spectrum for rate change from 1%-20%. It is noted that the SNDR remains unchanged.

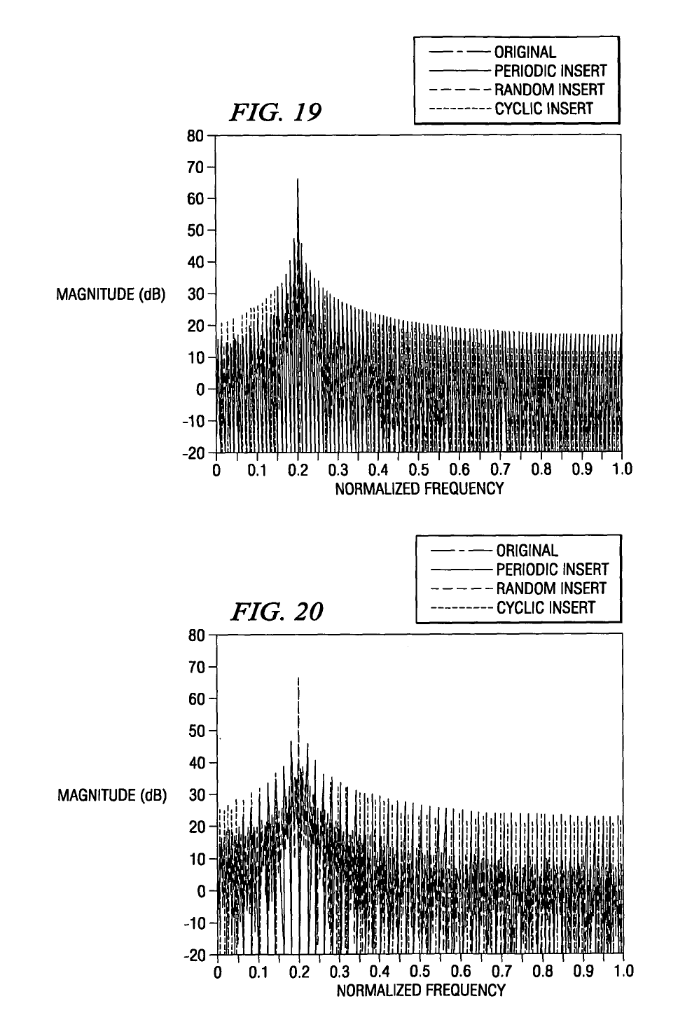

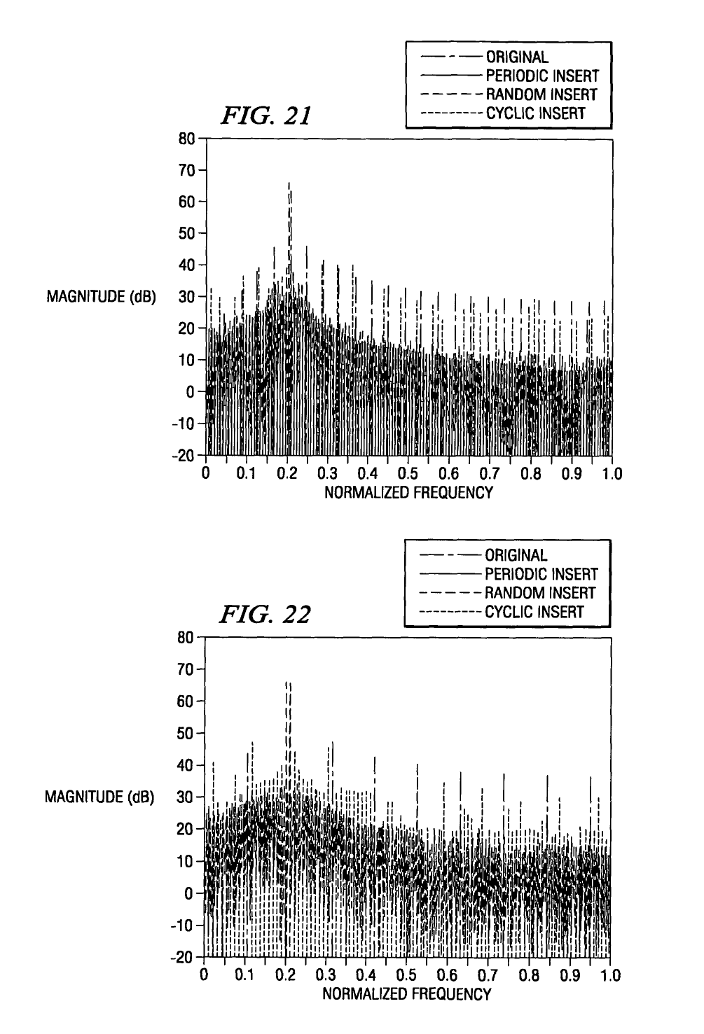

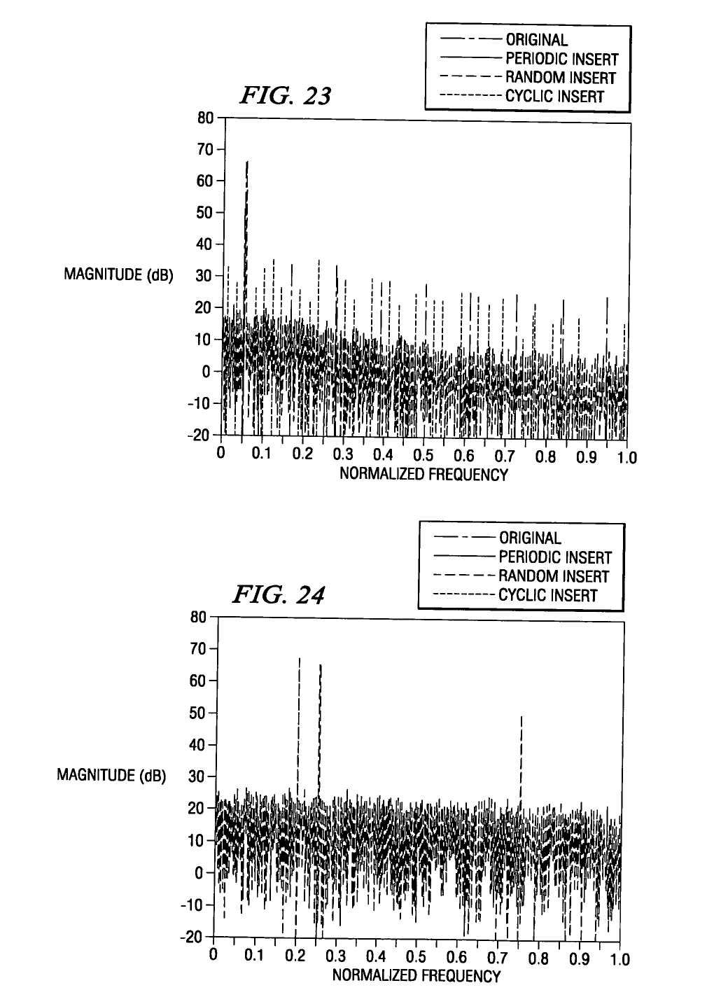

A similar scheme is constructed for down-sampling where data is deleted to reduce the rate. Again, the four approaches were investigated by the present inventors to evaluate the SNDR degradation. The corresponding plots are shown in FIGS. 19-24

In FIG. 12, the non-interpolative scheme up-samples the data stream at the output of DFIR-1 by re-clocking this data with the new higher clock while inserting intermittent new data samples. The cost of this scheme is a few registers. Since the SNDR is above the requirement for the demodulator, the spectrum shown in FIGS. 13-18 is acceptable for the demodulator to obtain the required BER. The position of the resampler ensures that it requires negligible power.

Another option is to place the resampler after the ADC output before the DFIR-1. In this scheme, the collective DFIR will not improve the SNDR of the system; however, the input to the demodulator will only have frequency components around the channel of interest. This scheme is shown in FIG. 25.

Clock Generation for Resampling

The clock generation for up-sampling can be performed using fractional division of the f_{LO} or its division. A clock in the vicinity of 300 MHz can be used as the source frequency in either mode. Although a higher source frequency will improve the phase noise of the fractionally divided clock, it is not necessary to obtain such high degree of performance in handing off data to the demodulator at such low rates. The phase noise performance can be improved by using a digital sigma-delta fractional-N divider as shown in FIG. 12.

Resampling Fixed Rate Data to Variable Rate

The solutions described herein before can also be used in any other scheme which requires data resampling to convert fixed rate data to variable rate. In such a scheme the input to the resampler is applied at a fixed rate and the fractional-N divider provides the clock for the desired data rate. Again, the fractional-N divider may generate the output clock using a sigma-delta fractional-N division, if so desired. The higher clock rate is used to interpolate the fixed rate data stream using insertion of zeros or repeating the last value or any other approach. The subsequent decimation filter gets rid of the image in addition to other possible applications such as droop and phase compensation. In this scheme, the resampler demarcates the boundary where the data shifts over for the fixed rate clock to the channel (or any auxiliary input) dependent rate clock (variable rate).

In summary explanation, in an application where channel dependent data rate is to be converted to a fixed rate data, the present inventors described a plurality of options for doing so in a digital manner. They have shown that such rate conversion can be done very simply in a MTDSM based receiver by addition of a fractional-N division to obtain the fixed rate clock. A clock derived from a local oscillator (LO) is used as a source for the fractional-N division to obtain the desired fixed rate clock at the cost of an estimated few hundred gates. The rate change can be accomplished using a fractional delay structure to keep a high SNDR at the cost of a filter bank following the ADC. The location of this structure can precede some decimation stages along the digital filter chain. If an SNDR of 25 dB is considered enough, no such structure needs to be added and the non-interpolative rate conversion technique may be used.

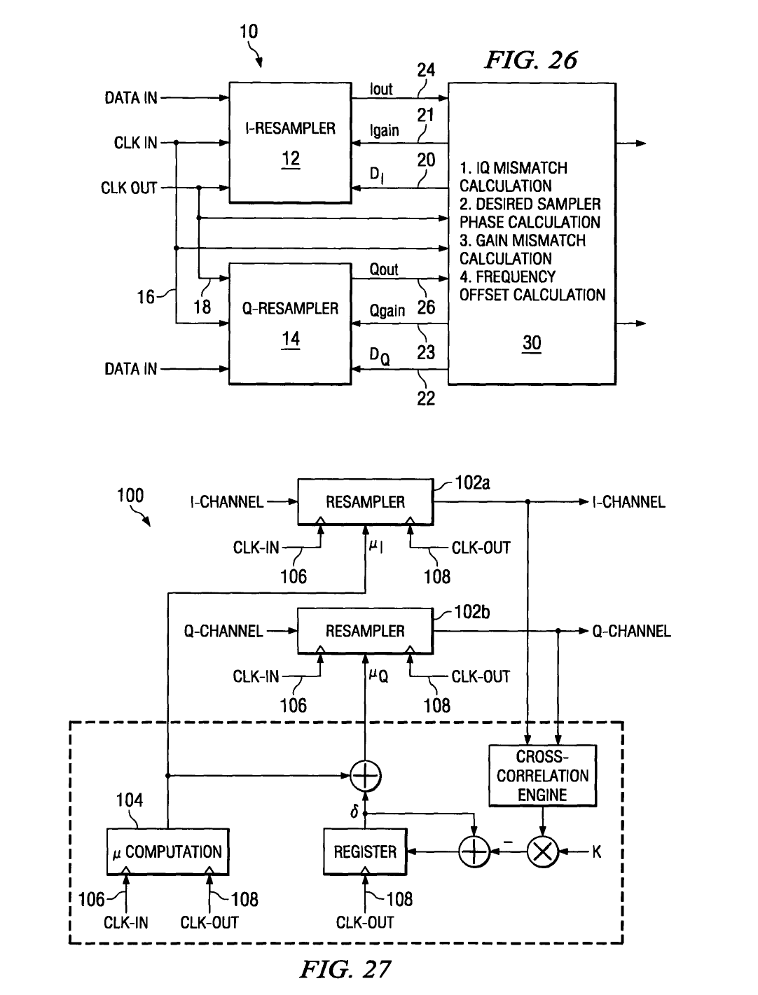

Keeping the foregoing discussion in mind, and looking now at FIG. 26, a simplified block diagram illustrates a system architecture 10 for implementing rate conversion together with in-phase/quadrature (IQ) mismatch correction and sampler phase adjustment in direct sampling based down-conversion according to one embodiment of the present invention. More specifically, the system architecture 10 combines the interpolation operation with IQ imbalance correction to convert the rate while compensating for the mismatch. According to one embodiment, the resampler 12, 14 is implemented using a Farrow structure such as discussed herein before, and that is well known to those skilled in the art. A Farrow structure is the most commonly used implementation in digital resampling, and implements interpolation to arbitrary phase delay using a bank of fixed coefficient FIR filters independent of the desired phase delay. Then the delay ‘d’ is constantly tracked for the value that is to be interpolated and used in conjunction with the polynomial implemented in the resampler. The value of ‘d’ is computed based on the offset of a local oscillator derived clock from the desired fixed rate clock. This is shown in FIG. 26 where the resamplers 12, 14 on I and Q branches respectively are provided with I and Q data streams, respectively, on the local oscillator derived clock (clock in) 16. The clock (clock out) 18 at which the output data is to be read comes from the baseband section and is used to read out the interpolated data.

By adding a fixed offset to ‘d’(d_{I} 20 or d_{Q} 22) in one of the two paths (I and Q), the phase of the interpolated value can be shifted with respect to the other path thereby providing a simple means of compensating for the IQ imbalance. Separate gains 21, 23 can be provided to the two paths independently to provide a means for gain compensation. The value of ‘d’ 20, 22 can be calculated by an IQ mismatch calculation engine as shown in block 30 which inspects the I and Q outputs 24, 26 and adjusts the value of ‘d’ 20, 22 accordingly on the two paths.

The I and Q outputs 24, 26 are used to control the interpolation time instant. Further, an offset can be added to both the I and Q path ‘d’ values to advance or reverse the phases of the two signals at the same time. This can be used to align the sampling instant of the following stage with respect to the phase of the input signal. An algorithm can be easily implemented to select the best sampling instant and control the value of ‘d’ to align the sampling instant with the best phase. This approach can then be used to control the best sampling phase of the input data stream such that a T-spaced equalizer performance can be made insensitive to the sampler phase. In this case a fractional spaced equalizer is no longer required.

The calculation engine 30 can be seen to include algorithmic software for determining the I-Q mismatch 1, a desired sampler phase 2, any/or any gain mismatch 3. The calculation engine 30 may comprise, but is not limited to, a DSP, CPU, micro-controller, microcomputer, or any other like data processor capable of processing digitally sampled data along with a means for storing digital data.

In summary explanation, a rate conversion scheme combines IQ mismatch removal in conjunction with sampling rate alteration by using a digital resampler. This approach was found by the present inventors also to be useful to adjust the phase of the sampler such that a T-spaced equalizer may be used in the RF receiver baseband section instead of a fractionally spaced equalizer

FIG. 27 is a block diagram illustrating an algorithm 100 for implementing IQ phase mismatch cancellation in a quadrature receiver using a polynomial resampler according to one embodiment of the present invention. It can be appreciated that in a quadrature receiver, the phase mismatch between I and Q channels manifests itself as a non-zero cross-correlation between the I and Q data. In other words, if there were no phase mismatch between I an Q channels, the cross-correlation between I and Q data would be zero. Algorithm 100 then describes a method to decorrelate the I and Q data using identical polynomial resamplers 102a,b in the I and Q branches, but with different fractional delay values (μ). Parameter μ for one of the branches is adjusted according to some cross-correlation measure between I and Q data.

With continued reference to FIG. 27, algorithm 100 can be seen to include two identical resamplers 102a,b used in the I and Q branches, as stated herein before. There is a μ computation block 104 that computes μ based on the input and output clocks 106, 108. This μ goes as such (called μ_{I} in FIG. 27) to the I-channel resampler 102a. However, μ_{Q} is different from μ_{I} by a value δ that is dependent on cross-correlation between I and Q data. Mathematically, the output of most common implementations of a polynomial resampler can be expressed as:
y(n)=f₁(n)+μ(n)f₂(n)+μ(n)²f₃(n)+μ(n)³f₄(n),
where fᵢ(n), i=1, 2, 3, 4 are outputs of the four filter branches inside the resampler at instant n and μ(n) is the value of μ at instant n. If there were no phase mismatch, then μ(n) would be a function of the delay between edges of the input and output clocks. In the presence of phase mismatch, μ(n) going to one of the branches (Q in FIG. 27) is modified by a factor δ that is dependent on cross-correlation between I and Q. One possible computation of δ is presented mathematically as follows:
δ(n)=δ(n−1)−KDₒᵤₜ₋₁(n)D_{out-Q}(n),
μ_{Q}(n)=μ₁(n)+δ(n),
where K is a constant dependent on the energy of the signal.

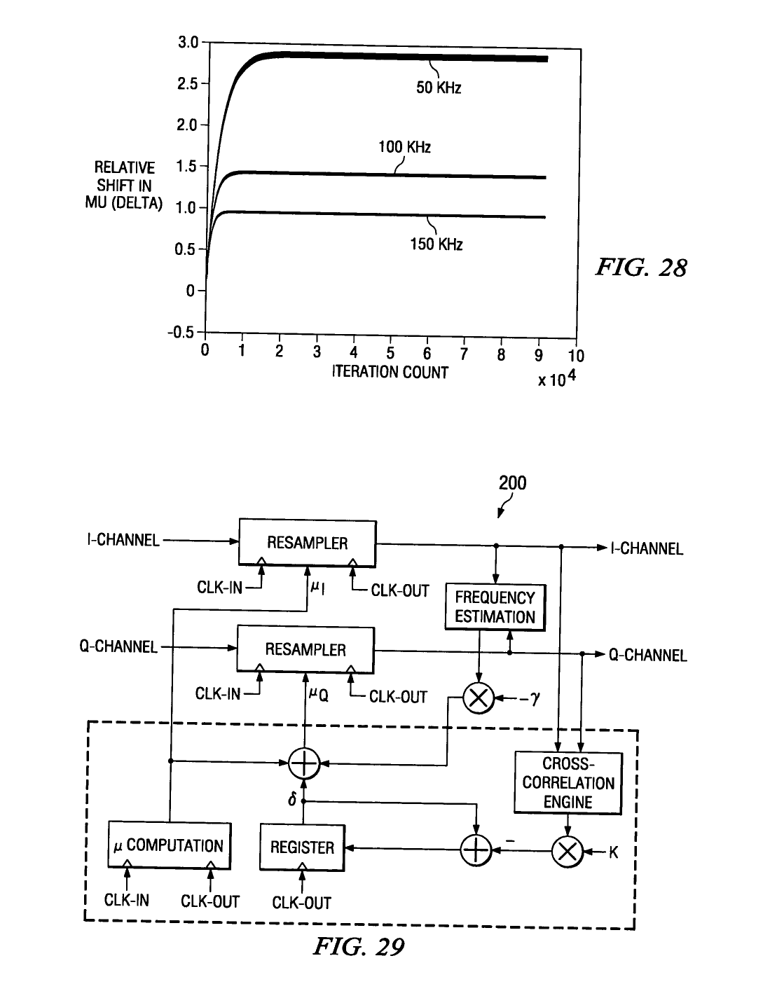

As presented herein above, it is easy to show that δ depends on the frequency of the signal. This is because δ represents a shift in the time domain, and since θ=2π ft, this implies that for a constant phase offset (θ), the shift in time, t, and hence δ, should be inversely related to the frequency of the signal. The value of δ computed for one frequency therefore, can not be directly used for another frequency. In other words, the IQ mismatch correction mechanism as presented above does not apply to a wideband signal. FIG. 28 shows the convergence properties of δ for three different frequencies.

Wider Band IQ Phase Mismatch Correction

It is possible to modify the μ-update algorithm presented above such that it supports wider band operation. The basic idea is to achieve convergence for δ for the center frequency of the band over which IQ mismatch correction is desired, and then modify δ according to some measure of the instantaneous frequency of the signal. FIG. 29 depicts an update of the IQ mismatch algorithm 100 block diagram to support a wider band operation than previously described in association with FIG. 27. There is a variety of techniques available in signal processing literature to get an estimate of the instantaneous frequency of the signal. In one possible embodiment, frequency is estimated as a derivative of the instantaneous phase of the complex signal, i.e., 2πf=dθ/dt. The wider band IQ phase mismatch correction algorithm 200 shown in FIG. 29 can be seen to include a proportionality constant −γ. The negative sign is necessary to increase δ for frequencies lower than the center frequency and vice-versa.

Correction of Gain Mismatch

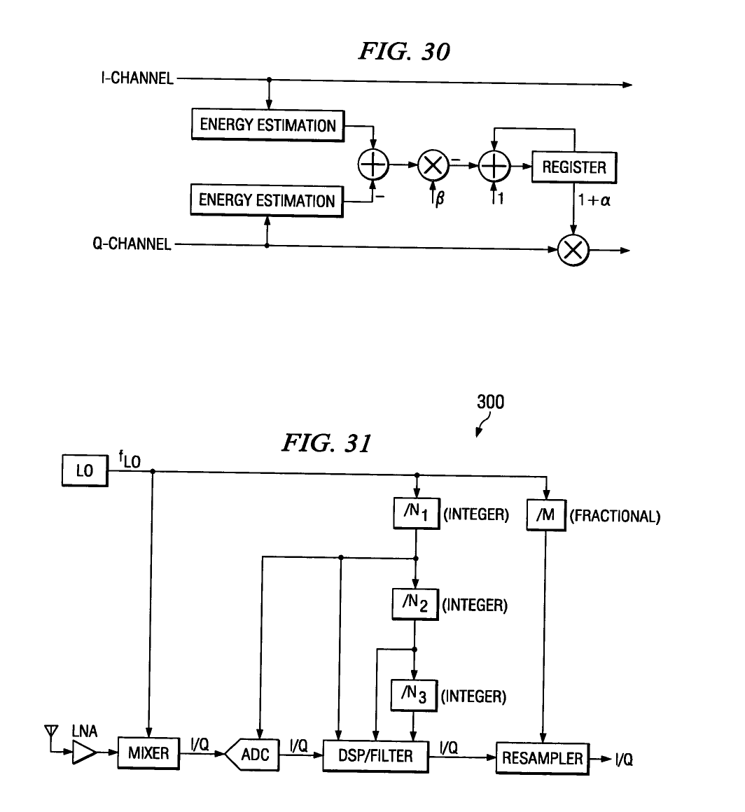

Correction of gain mismatch is relatively straight forward and does not require the presence of a resampler; however, the mechanism can be embedded inside the resampler. One possible technique of gain mismatch correction is described herein below to further enhance understanding of the embodiments described herein before, and to provide further completeness. In this regard, FIG. 30 depicts a block diagram of one possible embodiment of implementing correction of gain mismatch. It can be seen that the signal in the Q-brance is multiplied by 1+α to correct for gain mismatch, where α is computed based on the energy (or equivalently autocorrelation) difference between I and Q channel signals. In FIG. 30, β determines the convergence rate of α. The value of β is dependent on the energy of the signal. Gain mismatch correction can be applied to the Q-branch (sign of α will be different) or divided between both I and Q branches.

Other alternative implementations are also possible; one case would be to find the maximum and minimum values on the I and Q channel and to determine the peak value by taking the (maximum−minimum)/2. The value of (maximum+minimum)/2 determines the dc-offset. The dc-offset can be removed using this approach by subtracting this out of both the I and Q branches. Again, this scheme does not require the presence of a resampler; however, this scheme can be embedded inside the resampler structure.

Looking now at FIG. 31, a top level block diagram 300 illustrates one application of a resampling technique within a complete RX chain in accordance with the concepts described herein before.

In view of the above, it can be seen the present invention presents a significant advancement in the art of discrete time RF technology. Further, this invention has been described in considerable detail in order to provide those skilled in the art of direct sampling based down-conversion, with the information needed to apply the novel principles and to construct and use such specialized components as are required.

It should be apparent that the present invention represents a significant departure from the prior art in construction and operation. However, while particular embodiments of the present invention have been described herein in detail, it is to be understood that various alterations, modifications and substitutions can be made therein without departing in any way from the spirit and scope of the present invention, as defined in the claims which follow. For example, while certain embodiments set forth herein illustrate various hardware implementations, the present invention shall be understood to also parallel structures and methods using software implementations as set forth in the claims. Further, although a resampler embodiments have been shown to implement rate up-conversion, interpolative resamplers are equally useful for rate down-conversion.

1. A radio receiver architecture comprising:
a digital resampler comprising:
an I-resampler unit; and
a Q-resampler unit, wherein the digital resampler is operational to generate interpolated I and Q output data in response to an I-resampler delay signal, a Q-resampler delay signal, and further in response to I and Q input data streams synchronized on a local oscillator derived clock, such that the interpolated I and Q output data rate is substantially fixed and substantially independent of channel frequency variations.

2. The radio receiver architecture according to claim 1, further comprising:
a calculation engine comprising:
a data storage unit storing the interpolated I and Q output data;
an algorithmic software; and
a data processor, wherein the data processor, controlled by the algorithmic software, is operational to calculate an IQ mismatch in response to the stored interpolated I and Q output data, and adjust at least one resampler delay signal value in response thereto.

3. The radio receiver architecture according to claim 1, wherein the I and Q input data streams are channel dependent based on the oscillator derived clock.

4. The radio receiver architecture according to claim 2 wherein the calculation engine data processor, controlled by the algorithmic software, is operational to calculate a phase mismatch in response to the stored interpolated I and Q output data, and adjust at least one resampler delay signal in response thereto such that any IQ imbalance associated with the interpolated I and Q output data is substantially compensated when the IQ mismatch is phase related.

5. The radio receiver architecture according to claim 2 wherein the calculation engine data processor, controlled by the algorithmic software, is operational to calculate a gain mismatch in response to the stored interpolated I and Q output data, and generate resampler gain control signals in response thereto such that any gain mismatch associated with the interpolated I and Q output data is substantially compensated when the IQ mismatch is gain related.

6. The radio receiver architecture according to claim 2 wherein the calculation engine data processor, controlled by the algorithmic software, is further operational to calculate a frequency offset based on the relationship of the local oscillator derived clock with a desired fixed rate clock, and adjust the I-resampler and Q-resampler delay signal phases simultaneously in response thereto to align a sampling instant with a desired phase.

7. A method of converting a channel dependent sampling rate to a fixed rate, the method comprising the steps of:
providing a radio receiver comprising a digital resampler having an I-resampler unit responsive to a first delay signal and a Q-resampler unit responsive to a second delay signal, and further having a calculation engine; and
resampling channel dependent I-phase input data and the channel dependent Q-phase input data in synchronization with a local oscillator derived clock and in response to in phase (I) and quadrature (Q) resampling signals and generating interpolated I and Q output data therefrom.

8. The method according to claim 7 further comprising the steps of:
calculating an IQ mismatch in response to the interpolated I and Q output data; and
adjusting the first and second delay signals in response to the IQ mismatch such that the digital resampler interpolation operation is combined with IQ imbalance correction to convert the channel dependent sampling rate to a fixed rate while compensating for the mismatch.

9. The method of converting a channel dependent sampling rate to a fixed rate according to claim 8 further comprising the steps of:
calculating a frequency offset based on the relationship of the local oscillator derived clock with a desired fixed rate clock; and
adjusting at least one delay signal in response to the frequency offset such that the phase of the interpolated signal associated with the adjusted delay with respect to the other interpolated signal path is shifted to substantially compensate for IQ imbalance.

10. The method of converting a channel dependent sampling rate to a fixed rate according to claim 8 further comprising the steps of:
calculating a gain mismatch based on the interpolated I and Q output data; and
adjusting an I-resampler gain compensation signal and a Q-resampler gain compensation signal to provide independent gain compensation within the digital resampler.

11. The method of converting a channel dependent sampling rate to a fixed rate according to claim 8 further comprising the steps of:
determining a substantially best sampler phase in response to the interpolated I and Q output data, the local oscillator derived clock, and a desired fixed rate clock; and
simultaneously adjusting the first and second delay signals such that a substantially best sampling instant is aligned with the substantially best sampler phase.

12. A radio receiver architecture comprising a digital resampler operational to generate interpolated I and Q output data in response to an I-resampler delay signal, a Q-resampler delay signal, and further in response to I and Q input data streams synchronized on a local oscillator derived clock, such that the interpolated I and Q output data rate is substantially fixed and substantially independent of channel frequency variations.

13. The radio receiver architecture according to claim 12, further comprising a calculation engine operational to calculate an IQ mismatch in response to the interpolated I and Q output data, and adjust at least one resampler delay signal value in response thereto.

14. A radio receiver architecture operating at least partially in a sampled domain such that the sampling rate throughout the receive path is directly derived from a local oscillator clock, and wherein the local oscillator output clock edges are divided by an integer number, and further wherein the divided output clock edges and derivatives thereof are operational to generate decimated signal sampling clocks.

15. The radio receiver architecture according to claim 14, wherein the sampling rate throughout the receive path is channel dependent and is not intentionally based on multiples of the symbol-rate.

16. The radio receiver architecture according to claim 14, wherein an output sampling rate associated with the receive path comprises an unintentional non-integer multiple of a desired sampling rate.

17. The radio receiver architecture according to claim 14, wherein the architecture comprises:
a digital resampler operational to generate interpolated I and Q output data in response to an I-resampler delay signal, a Q-resampler delay signal, and further in response to I and Q input data streams synchronized on the local oscillator derived clock, such that the interpolated I and Q output data rate is substantially fixed and substantially independent of channel frequency variations.

18. The radio receiver architecture according to claim 17, wherein the resampler comprises an interpolator.

19. The radio receiver architecture according to claim 17, further comprising a phase/frequency adjustment system operational to calculate an IQ mismatch in response to the interpolated I and Q output data, and adjust at least one resampler delay signal value in response thereto.

20. A radio receiver architecture comprising a digital resampler operational to generate interpolated I and Q output data in response to at least one resampler delay signal, and further in response to I and Q input data streams synchronized on a local oscillator derived clock, such that the interpolated I and Q output data rate is substantially fixed and substantially independent of channel frequency variations.

21. The radio receiver architecture according to claim 20, wherein the digital resampler comprises:
an I-resampler unit; and
a Q-resampler unit, wherein the at least one resampler delay signal is selected from the group consisting of an I-resampler delay signal, and a Q-resampler delay signal.

22. The radio receiver architecture according to claim 20, wherein the I and Q input data streams are channel dependent based on the oscillator derived clock.

23. The radio receiver architecture according to claim 21, further comprising:
a calculation engine comprising:
a data storage unit storing the interpolated I and Q output data;
an algorithmic software; and
a data processor, wherein the data processor, controlled by the algorithmic software, is operational to calculate a mutual mismatch in response to the stored interpolated I and Q output data, and adjust at least one resampler delay signal value in response thereto.

24. The radio receiver architecture according to claim 23 wherein the calculation engine data processor, controlled by the algorithmic software, is operational to calculate a phase mismatch in response to the stored interpolated I and Q output data, and adjust at least one resampler delay signal in response thereto such that any IQ imbalance associated with the interpolated I and Q output data is substantially compensated when the mutual mismatch is phase related.

25. The radio receiver architecture according to claim 23 wherein the calculation engine data processor, controlled by the algorithmic software, is operational to calculate a gain mismatch in response to the stored interpolated I and Q output data, and generate resampler gain control signals in response thereto such that any gain mismatch associated with the interpolated I and Q output data is substantially compensated when the mutual mismatch is gain related.

26. The radio receiver architecture according to claim 23 wherein the calculation engine data processor, controlled by the algorithmic software, is further operational to calculate a frequency offset based on the relationship of the local oscillator derived clock with a desired fixed rate clock, and adjust the I-resampler and Q-resampler delay signal phases simultaneously in response thereto to align a sampling instant with a desired phase.

27. A method of converting a channel dependent sampling rate to a fixed rate, the method comprising the steps of:
providing a radio receiver comprising a digital resampler responsive to at least one delay signal, and further having a calculation engine; and
resampling channel dependent input data in synchronization with a local oscillator derived clock and in response to resampling signals and generating interpolated output data therefrom.

28. The method according to claim 27 further comprising the steps of:
calculating a mutual mismatch in response to the interpolated output data; and
adjusting at least one delay signal in response to the mutual mismatch such that the digital resampler interpolation operation is combined with a mutual imbalance correction to convert the channel dependent sampling rate to a fixed rate while compensating for the mismatch.

29. The method of converting a channel dependent sampling rate to a fixed rate according to claim 28 further comprising the steps of:
calculating a frequency offset based on the relationship of the local oscillator derived clock with a desired fixed rate clock; and
adjusting at least one delay signal in response to the frequency offset such that the phase of the interpolated signal associated with the adjusted delay with respect to the other interpolated signal path is shifted to substantially compensate for the mutual imbalance.

30. The method of converting a channel dependent sampling rate to a fixed rate according to claim 28 further comprising the steps of:
calculating a gain mismatch based on the interpolated output data; and
adjusting a at least one gain compensation signal to provide independent gain compensation within the digital resampler.

31. The method of converting a channel dependent sampling rate to a fixed rate according to claim 28 further comprising the steps of:
determining a substantially best sampler phase in response to the interpolated output data, the local oscillator derived clock, and a desired fixed rate clock; and
simultaneously adjusting at least one signal such that a substantially best sampling instant is aligned with the substantially best sampler phase.

32. A radio receiver architecture comprising a digital resampler operational to generate interpolated output data in response to at least one resampler delay signal, and further in response to input data streams synchronized on a local oscillator derived clock, such that the interpolated output data rate is substantially fixed and substantially independent of channel frequency variations.

33. The radio receiver architecture according to claim 32, further comprising a calculation engine operational to calculate a mutual mismatch in response to the interpolated output data, and adjust at least one resampler delay signal value in response thereto.
